(19) United States
(12) Patent Application Publication
(10) Pub. No.: US 2015/0345685 A1
(43) Pub. Date: Dec. 3, 2015

(54) MULTI-PART, MANIFOLD AND METHOD OF MAKING THE MANIFOLD

(71) Applicant: SPX FLOW, INC., Charlotte, NC (US)

(72) Inventors: Michael T. LANDRUM, Rockford, IL (US); Dwight Booth, Milton, WI (US)

(21) Appl. No.: 14/821,985

(22) Filed: Aug. 10, 2015

Related U.S. Application Data
(63) Continuation-in-part of application No. 14/716,755, filed on May 19, 2015.
Application No. 14/716,755 is a continuation-in-part of application No. 13/937,509, filed on Jul. 9, 2013.

(51) Int. Cl. F16L 41/02

(52) U.S. Cl. CPC F16L 41/02

(57) ABSTRACT

A manifold is provided. The manifold includes: a first body having an outer surface; a second body having an inner surface corresponding to the outer surface of the first body and the first body is micro-welded to the second body; and a groove formed in one or both of the outer and inner surfaces, wherein the first body is dimensioned to fit within the second body so that the outer surface contacts the inner surface and the groove forms a fluid passage located between the first and second bodies, the fluid passage having an inlet and an outlet. Also in some embodiments a method of forming a manifold is provided. The method includes: filling a die with powdered metal having grains; compressing the powdered metal in the die thereby forming a first body; removing the compressed part from the die; contacting the first body to a second body subjecting the bodies to heat; and forming micro-weld between grains of metal between the two bodies.

### CROSS-REFERENCE TO RELATED APPLICATIONS

This application claims priority to, and is a continuation-in-part application of, pending U.S. patent application entitled, “A Muli-Part, Tapered, Concentric Manifold and Method of Making the Manifold” filed May 19, 2015, having Ser. No. 14/716,755 which is a continuation-in-part application of, pending U.S. patent application entitled, A Multi-Part Concentric Manifold and Method of Making the Manifold, filed Jul.,9, 2013, having Ser. No. 13/937,509. Priority to of all of the above mentioned applications is claimed herein and the disclosure of these applications are incorporated herein by reference in their entirety.

### FIELD OF THE INVENTION

The present invention relates generally to a manifold. More particularly, the present invention relates to a multipart, concentric, tapered, compact manifold.

### BACKGROUND OF THE INVENTION

Manifolds are traditionally used to assist in the routing of various fluids. Often a single housing or block will have various pathways formed or machined in it in order to provide conduits for the fluid. Commonly, the housings or blocks are angular or rectangular shape. In many instances, the pathways are machined along horizontal or vertical surfaces. Or, in other words, generally in a straight line along a straight surface. However, there may be instances where a rectangular shaped manifold housing is not best suited. Furthermore, other manifold housing shapes may allow for a more compact design than conventional shapes.

Accordingly, it is desirable to provide a manifold and/or a method for making a manifold that may have a geometric shape other than rectangular.

### SUMMARY OF THE INVENTION

The foregoing needs are met, to a great extent, by the present invention, wherein in one aspect an apparatus is provided that in some embodiments a manifold may have a non-rectangular shape and may be more compact.

In accordance with one embodiment of the present invention, a manifold is provided. The manifold includes: a first body having an outer surface; a second body having an inner surface corresponding to the outer surface of the first body and the first body is micro-welded to the second body; and a groove formed in one or both of the outer and inner surfaces, wherein the first body is dimensioned to fit within the second body so that the outer surface contacts the inner surface and the groove forms a fluid passage located between the first and second bodies, the fluid passage having an inlet and an outlet.

In accordance with another embodiment of the present invention, a method of forming a manifold is provided. The method includes: filling a die with powdered metal having grains; compressing the powdered metal in the die thereby forming a first body; removing the compressed part from the die; contacting the first body to a second body subjecting the bodies to heat; and forming micro-weld between grains of metal between the two bodies.

In accordance with yet another embodiment of the present invention, a manifold is provided. The manifold includes: a first body having an outer surface; a second body having an inner surface corresponding to the outer surface of the first body, the first body is micro-welded to the second body; and a means for allowing fluid to move through a body formed in one or both of the outer and inner surfaces, wherein the first body is dimensioned to fit within the second body so that the outer surface contacts the inner surface and the means for allowing fluid to move through a body forms a fluid passage located between the first and second bodies, the fluid passage having an inlet and an outlet.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an exploded perspective view of a manifold in accordance with an embodiment.

FIG. 2 is a perspective view of a manifold in accordance with an embodiment.

FIG. 3 is a perspective view of a manifold in accordance with another embodiment.

FIG. 4 is an exploded, perspective view of a manifold in accordance with an embodiment.

FIG. 5 is an exploded view of a manifold in accordance with another embodiment.

FIG. 6 is an assembled view of the embodiment shown in FIG. 5.

FIG. 7 is an exploded view of another embodiment in accordance with the present disclosure.

FIG. 8 is an assembled view of the embodiment illustrated in FIG. 7.

FIG. 9 is a partial, enlarged view of a manifold assembled according to another embodiment.

FIG. 10 is a flow chart showing a method of how to manufacture a manifold according to another embodiment.

### DETAILED DESCRIPTION

According to some embodiments, a generally circular shaped manifold 10 is provided. The manifold 10 may include an inner body 12. The inner body 12 may have an outer surface 14 of the inner body 12. Optionally, the inner body 12 may have a void or hole 16 in its center portion. In other embodiments, the inner body 12 may be solid at the center portion.

Grooves or pathways 18, 20, 22, and 24 may be formed on the outer surface 14 of the inner body 12. The grooves 18, 20, 22, and 24 are pathways which allow a fluid to flow within the manifold 10. For example, in some embodiments, various axial pathways 26 may be fluidly connected to each other via the grooves or pathways 18, 20, 22, and 24.

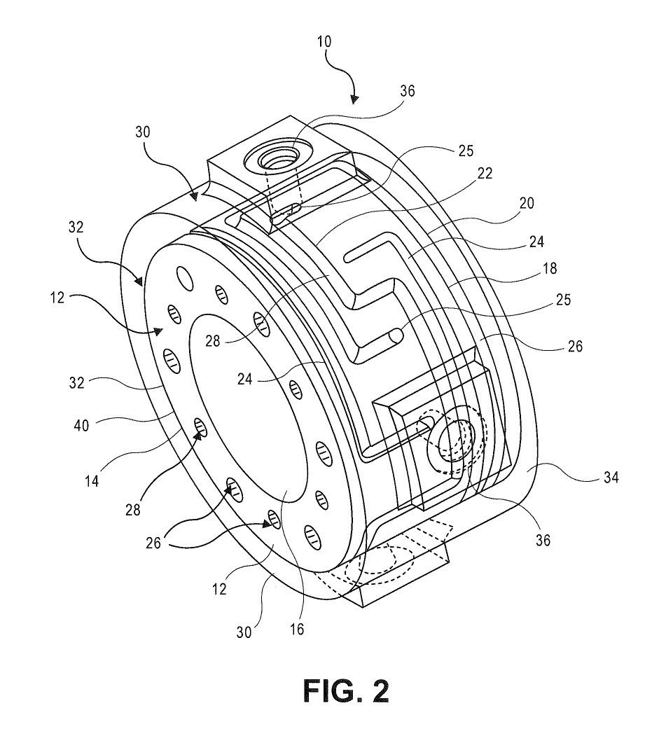

When the inner body 12 is tightly fit within the outer body 30, as shown in FIG. 2, the grooves or pathways 18, 20, 22, and 24 are fluidly isolated from each other. The fluid flows through the pathways 18, 20, 22, and 24 to provide fluid communication within the manifold 10 to various axial pathways 26. In some embodiments, the fluid may be hydraulic fluid. The hydraulic fluid may be at relatively high pressure so the fitting of the inner body 12 to the outer body 30 must the tightly fit or sealed to maintain fluid isolation between pathways 18, 20, 22 and 24. One of ordinary skill in the art after reviewing this disclosure will understand that the pressure of any fluids formed through the pathways 18, 20, 22, and 24, will need to be at a pressure less than a pressure required to separate the inner body 12 from the outer body 30 in order to maintain fluid isolation between the various pathways.

In some embodiments, the inner body 12 is press fit within the outer body 30. In other words, an initial dimension of the inner surface 32 of the outer body 30 may be smaller than the initial outer surface 14 of the inner body 12. In other embodiments of the invention, an adhesive may be used to fasten or seal the inner body 12 with in the outer body 30. In other embodiments, fasteners may be used.

In some embodiments, the outer body 30 may be heated so that the inner surface 32 expands. The inner body 12 may be then inserted into the outer body 30. When the outer body 30 cools it shrinks and tightly engages the inner body 12 at seam or connection 40. In other embodiments, other methods of connecting the inner 14 and outer body 30 may be used.

On the outer surface 34 of the outer member 30, hydraulic ports 36 are located about various positions. The positions of the hydraulic ports 36 coincide so that they align with one of the grooves or pathways 18, 20, 22, and 24 allowing fluid communication between the hydraulic ports 36 and one of the grooves or pathways 18, 20, 22, and 24. In some embodiments, the hydraulic ports 36 may be located on blocks 38 located on the outer surface 34 of the outer member 30 as illustrated in the FIGS. As configured in the FIGS, hydraulic fluid may flow either in or out of the hydraulic ports 36 through the grooves or pathways 18, 20, 22, and 24 and through the axial pathways 26. In some embodiments of the invention, the hydraulic ports 36 may be in fluid communication with one or more of the axial pathways 26.

The grooves 18, 20, 22, and 24 may also have turns 25. The turns 25 provide a radial opening to fluidly connect the grooves 18, 20, 22, and 24 to one or more axial pathways 26.

A hydraulic port 36 may be part of the specific pathway 27. As a result, hydraulic fluid may flow to or from a hydraulic port 36 to a specific axial pathway 27.

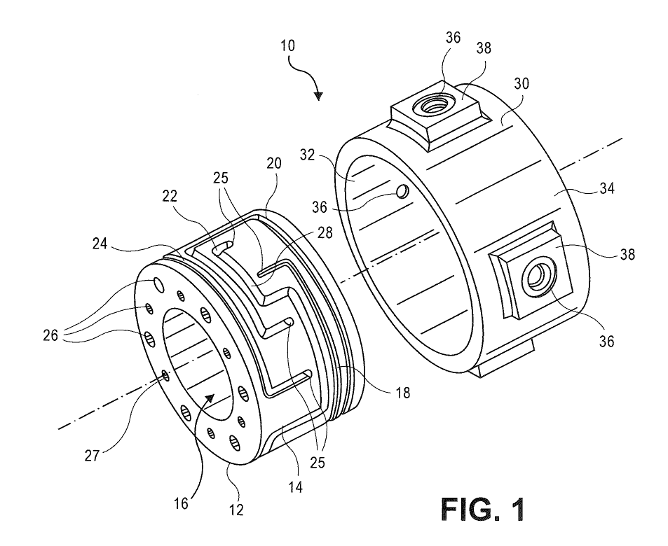

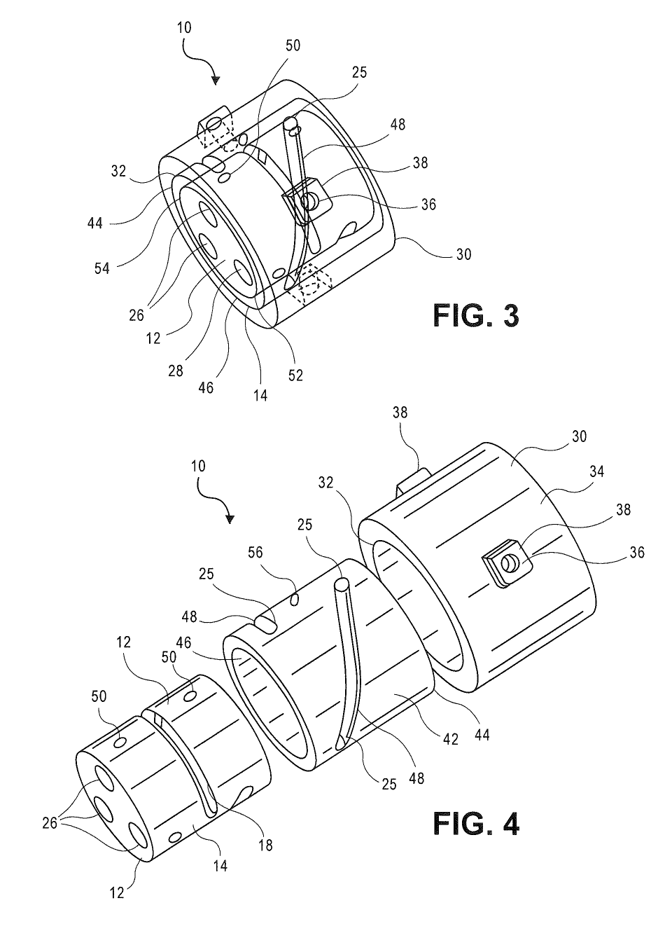

The turns 25 may terminate at the groove, 18, 20, 22, and 24 and be a through hole that fluidly connects the groove 22 to the axial pathways 26. However, the turns 25 are not limited to ends or terminations of the grooves 18, 20, 22 and 24 but may also occur at an intermediate point along the fluid pathway as illustrated by referenced numeral 27 in FIG. 1 along the pathway 22. Furthermore, the hydraulic ports 36 may be located over the turns 25 and the pathways 18, 20, 22, and 24 as illustrated in FIG. 2 or they may be located at intermediate positions on pathways as illustrated in FIGS. 3 and 4.

As an example, a specific hydraulic pathway indicated as referenced in numeral 28 may include specific axial pathway 27 and the groove indicated by reference numeral 22. The groove 22 is terminated with a turn 25 which provides fluid communication between the groove 22 and the axial pathways 26.

FIG. 4 is an exploded view and FIG. 3 is an assembled view of the manifold 10. In the embodiments shown in FIGS. 3 and 4, the manifold 10 includes and inner body 12 an intermediate body 42 and an outer body 30. The inner body 12 includes axial pathways 26, the axial pathways 26 are in fluid communication with the grooves 48, radial pathways 50 and the hydraulic ports 36.

The axial pathways 26 are connected via the radial pathway 50 to the turns 25. The turns 25 are fluidly connected to the groove 48 on the intermediate body 42 which is, in turn, fluidly connected to the hydraulic ports 36 in the blocks 38 on the outer body 30. Alternatively, the axial pathways 26 may be fluidly connected via the radial pathways 50 the groove 18 on the inner body 12. The groove 18 on the inner body 12 may be fluidly connected to one of the hydraulic ports 36 on the outer body, 30 via a second radial pathway 56 located on the intermediate body 42.

One of ordinary skill in the art after reviewing this disclosure will understand how to connect or isolate varies axial pathways 26 from various grooves 48, turns 25, a radial pathways 50 and hydraulic ports 36.

As a result, anyone of the axial pathways 26 may be connected to one of the hydraulic ports 36 through either a groove 18, 20, 22, or 24 on the inner body 12 or a groove 48 on the intermediate body 42 via the turns 25 or radial pathways 50. Thus, the fluid connections may be routed along the manifold 10 without being fluidly connected with each other. As shown in FIGS. 3 and 4, the pathways defined by the grooves 18 or 48 may even cross over each other (one pathway being on the inner body 12 and the other on the intermediate body 42) but are not fluidly connected.

While only a certain number of axial pathways 26, grooves 18, 20, 22 and 24, turns 25 being, radial pathways 50 and hydraulic ports 36 are shown, one of ordinary skill in the art will understand that more of fewer may be used to achieve a desired result.

Similar to that described above, the inner body 12 may fit within the intermediate body 42. The intermediate body 42 may fit within the outer body 30. It may be desirable in some embodiments for the connections 52 between the inner body 12 and the intermediate body 42 to be fluid tight so that fluid does not leak out from the groove 18 or the radial pathways 50. This may be accomplished in several ways. For example, the inner body 12 may be press fit with the intermediate body 42. In other embodiments, the intermediate body 42 is heated as to expand. Once the intermediate body 42 has expanded, the inner body 12 can be inserted into the intermediate body 42. As the intermediate body 42 cools, it will shrink, thereby tightening and making fluid tight the connection 52 between the inner body 12 and the intermediate body 42.

Similarly, it may be desirable for the connection between the intermediate body 42 and the outer body 30 to also be fluid tight. Similar to that described above, the intermediate body 42 may be press fit with the outer body 30. In some embodiments, the outer body 30 heated thereby expanding allowing the intermediate body 42 to be inserted into the outer body 30. As the outer body 30 cools, it will shrink and thereby form a fluid tight connection to the intermediate body 42.

In other embodiments the connection 52 between the intermediate body 42 and the inner body 12 and/or the connection 54 between the intermediate body 42 and the outer body 30 may also be accomplished using adhesives, sealants, and or fasteners in order to help the connections 52, 54 to be fluid tight. In other embodiments, other ways of fastening the bodies 12, 30 and 42 may be used.

It is anticipated that some embodiments that the fluid that will be flowing through the manifold will be hydraulic fluid under pressure. However, in other embodiments, other fluids may be used. Fluids may be in liquid or gas form. Hydraulic fluid is mentioned here only as an example and is in no way limiting the invention to hydraulic manifolds.

The grooves 18, 20, 22, 24 and 48 are shown and described to be on the outer surfaces 14 and 44 of the inner 12 or intermediate bodies 42. After reviewing this disclosure, one of ordinary skill in the art will appreciate that the grooves 18, 20, 22, 24 and 48 could also be located on the inner surfaces 32 and 46 of the intermediate 42 or outer 30 bodies or both. The outer surfaces 14 and 44 of the inner and intermediate bodies 12 and 42 and the inner surfaces 32 and 46 of the intermediate 42 and outer bodies 30.

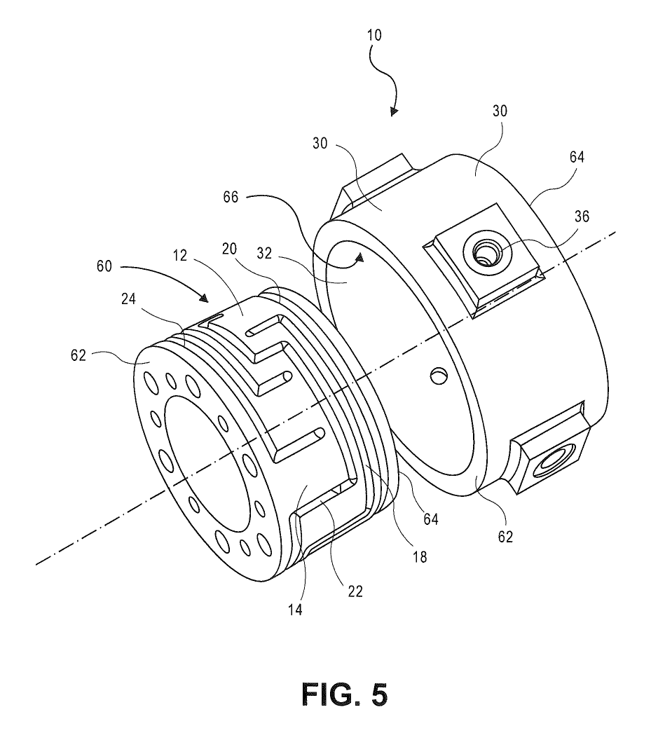

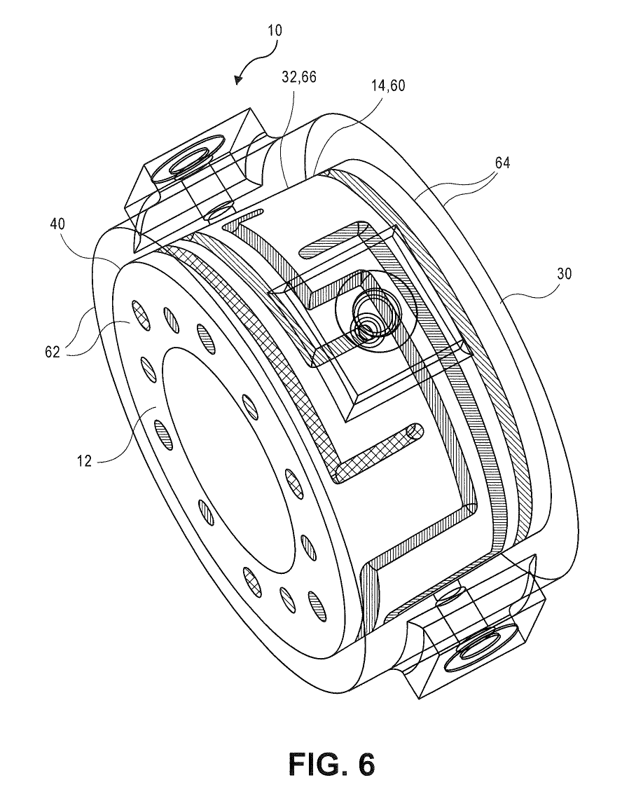

FIGS. 5-8 illustrate additional embodiments. The embodiment shown in FIGS. 5 and 6, is similar to the embodiment shown in FIGS. 1 and 2. The circular shaped manifold 10 includes and inner body 12 that fits into an outer body 30. The inner body 12 has an outer surface 14 that contains grooves 18, 20, 22, and 24. The inner body 12 fits into the outer body 30 in a fluid tight manner. As described above, the grooves 18, 20, 22 and 24 are configured to align with various hydraulic ports 36 as previously described above. In addition, the inner body 12 can be inserted into the outer body 30 with an interference fit and sealed in a manner similar described above.

In addition to a simple press fit, the inner body 12 can interact with the outer body 30 via a tapered surfaces 60 and 66. The outer surface 14 of the inner body 12 has a taper 60. The taper 60 is shaped so that the diameter of the inner body 12 is greater at the first end 62 than at the second end 64. The inner surface 32 of the outer body 30 also has a taper 66. The taper 66 is dimensioned so that the diameter of the void defined by the inner surface 32 is greater at the first end 62 than at the second end 64. By having the tapered shape 60 on the inner body 12 and the tapered shape 66 on the interior surface 32 of the outer body 30 the inner body 12 can fit more tightly within the outer body 30 as the inner body 12 is pushed or forced toward the second end 64 of the outer body 30. In this manner, the amount of press fit or interference fit between the inner body 12 and the outer body 30 can be regulated by the axial distance the inner body 12 is moved into the outer body 30.

FIG. 6 is an assembled view of the manifold 10 having an inner body 12 fit into the outer body 30. The inner body 12 meets with the outer body 30 at seamn or connection 40. The inner body 12 has a tapered 60 outer surface 14 and the outer body 30 has a tapered 66 inner surface 32. The first ends 62 of the inner body 12 and outer body 30 are substantially aligned and the second ends 64 of the inner body 12 and the outer body 30 are also substantially aligned. It should be understood, however, that perfect alignment of either the first ends 62 and the second end 64 is not likely in any particular embodiment because the inner body 12 may be pressed into the outer body 30 at various axial distances in order to achieve a desired interference fit as result of the taper 60 and 66.

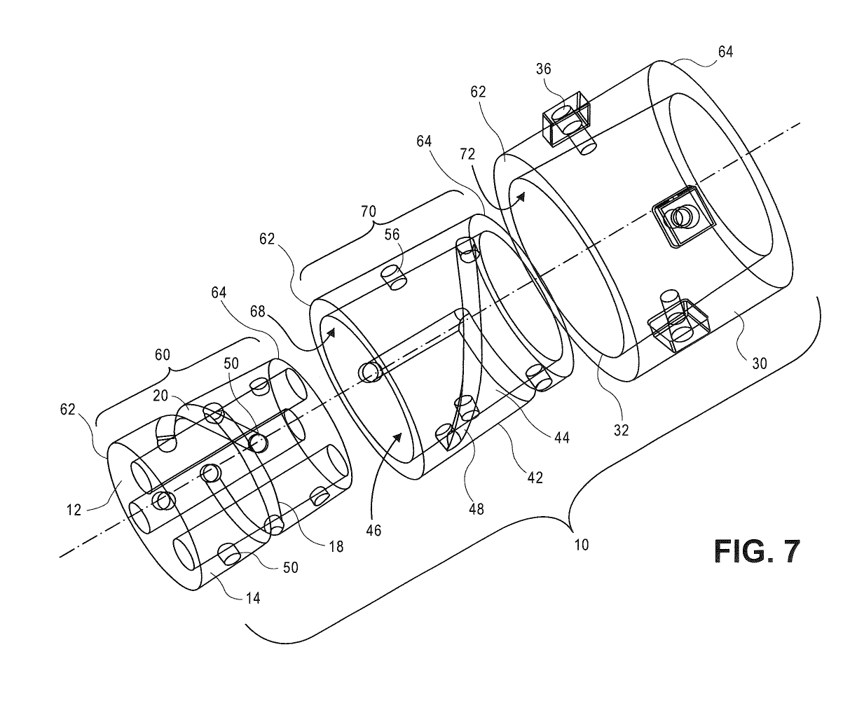

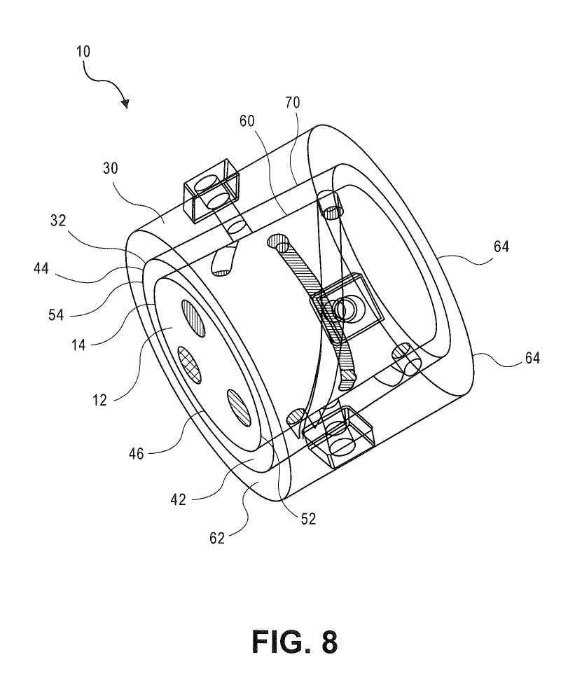

FIGS. 7 and 8 are similar to FIGS. 3 and 4 discussed above. As a result, many of the same features between FIGS. 7 and 8 and 3 and 4 will not be repeated here. Rather, mainly the differences will be discussed. FIG. 7 is an exploded view of a concentric manifold 10 and FIG. 8 is an assembled view. With reference to both FIGS. 7 and 8, the outer surface 14 of the inner body 12 has grooves 18, 20 that are fluidly connected to a radial pathways 50 similar to as described with respect to FIGS. 3 and 4. The inner body 12 has an outer surface 14 with a taper 60 as shown. The taper 60 results in the inner body 12 having a larger diameter at the first end 62 than at the second end 64.

An intermediate body 42 has an outer surface 44 which contains a groove 48 fluidly connected to a radial pathway 56 similar to that described above with respect to FIGS. 3 and 4. The intermediate body 42 has an interior surface 46 which has a taper 68. The taper 68 is dimensioned so that the diameter of the hollow portion defined by the interior surface 46 is larger at the first end 62 of the intermediate body 42 then the diameter of the interior space defined by the interior surface 46 at the second end 64 of the intermediate body 42.

In addition, the outer surface 44 of the intermediate body 42 also has a taper 70. The taper 70 is dimensioned so that the first end 62 of the intermediate body 42 has a larger diameter than the diameter of the intermediate body 42 at the second end 64.

The outer body 30 also has an interior surface 32 that has a taper 72. The taper 72 is configured so that the inner diameter of the void defined by the interior surface 32 has a larger diameter at the first end 62 then the inner diameter of the void defined by the inner surface 32 of the outer body 30 at the second end 64.

When the manifold 10 is assembled as shown in FIG. 8, the grooves 18, 20 and 48 (best seen in FIG. 7) as well as the radial pathways 50 are dimensioned and located so that the various ports 36, and 56 align to allow proper flow of fluid through the manifold 10 as described above. Tapered surfaces 60 and 68 will communicate as the inner body 12 is inserted into the intermediate body 42 to allow the inner body 12 to be sealed within the intermediate body 42. The tapered surfaces 60 and 68 allow for ease of manufacture to allow the inner body 12 to be moved axially within the intermediate body 42 to achieve a desired amount of seal and interference fit.

Likewise, the tapered surfaces 70 and 72 will communicate with each other to allow the intermediate body 42 to be inserted into the outer body 30 so that the intermediate body 42 can be fit and sealed within the outer body 30. Furthermore, the tapers 70 and 72 will provide ease of manufacturing to allow the intermediate body 42 to be moved axially within the outer body 30 so that the inner body 42 will be sealed into the outer body 30 and achieve a desired amount of interference fit.

It should be understood that a desired amount of interference fit can range from none at all to a relatively large amount. As discussed above, the inner body 12 and the intermediate body 42 and the intermediate body 42 and the outer body 30 may be sealed by various means including but not limited to: interference fits, sealants, welding, adhesives, and mechanical fasteners. It should also be understood that while the embodiments described herein show manifolds 10 having two or three bodies, other embodiments may include greater than three bodies in the manifold 10. Additional bodies may be fit similar to those described herein. Furthermore, more or fewer fluid pathways may also be used in some embodiments.

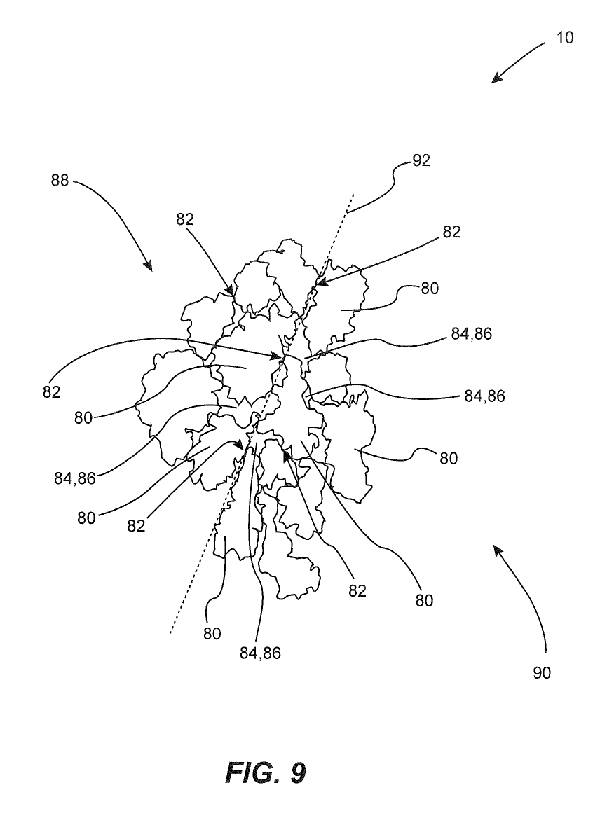

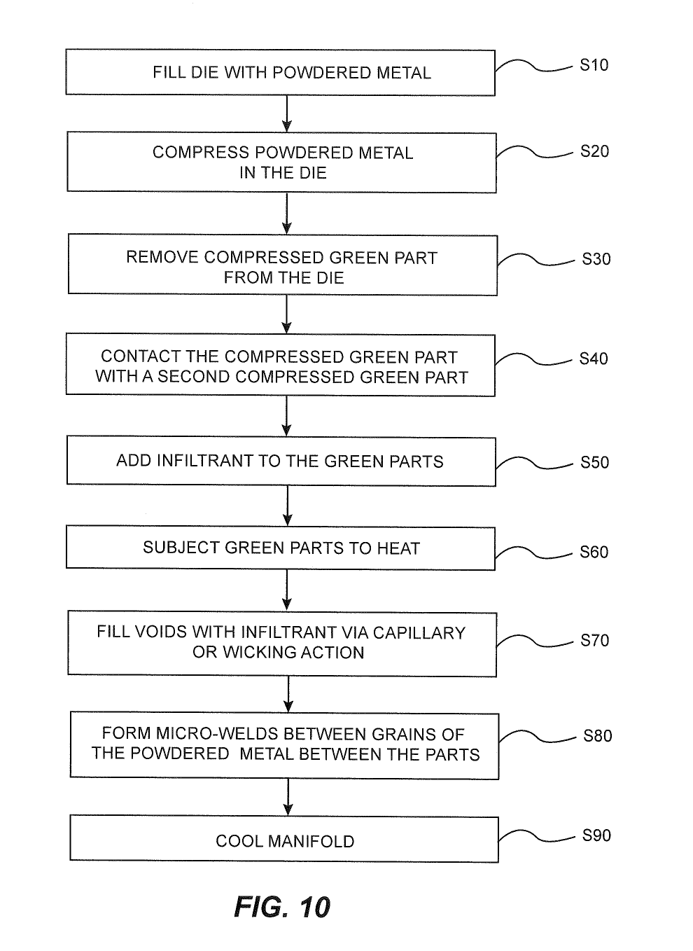

In an optional embodiment in accordance with the present disclosure, various bodies 12, 30, and 42 of the manifold 10 (as shown for example in FIG. 4) may be manufactured separately. The manufacturing of these bodies 12, 30, and 42 may be accomplished by the use of sintering powdered metals. After the individual bodies 12, 30, and 42 have been manufactured, the manifold 10 may be assembled. Upon assembly, a sintering step may be used to unify the various bodies 12, 30, and 42 (or just bodies 12 and 42 as the case may be) to form a unified manifold 10. Additional discussion with reference to FIGS. 9 and 10 will be discussed further below.

FIG. 9 illustrates a partial enlarged view of a manifold 10 including several grains 80 of the powdered metal that may be used in forming a manifold 10. For the purposes of the document herein the term “grains” will refer to the various particles or kernels of powdered metal. The various grains 80 shown in FIG. 9 have already been placed in a die, compressed in the die, and removed from the die. A part made of powdered metal that has been removed from the die but not yet subject to heat is referred to as a “green” part. In general, green parts will hold their shape due to the compression of the grains 80 within the die but once removed from the die, the green part may start to crumble when subjected to any significant forces. As such, green parts may be handled relatively gently.

As shown in FIG. 9, the grains 80 have contact points 82 in which the grains contact other grains 80. Voids 84 are located between the grains 80. In some embodiments, and will be discussed in further detail below, the avoids 84 may be filled or, at least partially filled, with an infiltrant 86.

As shown in FIG. 4 for example, the inner body 12 fits within the intermediate body 42 and the intermediate body 42 fits within the outer body 30. In another embodiment as illustrated in FIG. 1, the inner body 12 fits within the outer body 30. FIG. 9 illustrates an outer body 88 which could correspond to the outer body 30 or the intermediate body 42 of FIGS. 1 and 4. FIG. 9 also shows an inner body 90 which could correspond to the inner body 12 or the intermediate body 42 of FIGS. 1 and 4. The junction line 92 separates the outer body 88 from the inner body 90. The junction line 92 could correspond to the seam or connection 40 of FIG. 2 or the seam or connection 52 or 54 of FIG. 8.

Once the inner body 90 is placed within the outer body 88 as part of the assembly of the manifold 10, the inner body 90 can be attached to the outer body 88 by a micro-welding process according to the art of powdered metallurgy.

FIG. 10 is a flowchart illustrating various steps associated with assembling a manifold 10 in accordance to an embodiment of the disclosure. First, as set forth in step S10 dies configured to form the outer 88 or inner 90 bodies are filled with powdered metal. The powdered metal within the dies are compressed in step S20. The inner 88 and outer parts 90 are removed from the dies in step S30. The powdered metal parts (also refered to as bodies) 88 and 90, once they have been removed from the dies, are green parts, and are therefore handled carefully. The manifold 10 is assembled by placing the inner part 90 within a void which is defined in part by the innersurfaces 32 or 46 of the outer 30 or intermediate 42 bodies (see FIG. 4) which may be the outer part 88 (FIG. 9). If the manifold 10 comprises several parts or bodies 12, 30 and 42 as shown in FIG. 4, the various parts are assembled. Once assembled, the outer and inner parts 88 and 90 will contact each other as set forth at step forth in step S40.

Optionally, an infiltrant may be added to the green parts 88 and 90 at step S50. The adding of infiltrants to green parts is well known and will not be discussed in additional detail here. In some embodiments, the infiltrant may be metals such as copper, or any other suitable metal. In other embodiments, the infiltrants may include adhesives such as industrial and/or other suitable adhesives. Once the infiltrant has been added to the green parts 88, 90 the green manifold 10 (which will include various green parts 88, 90 in an assembled condition) will be subjected to heat as set forth in step S60. In some embodiments, subjecting the green manifold 10 to heat includes placing the green manifold 10 in an oven. Other embodiments may include subjecting the green manifold 10 to heat by passing high amounts of current through the green manifold 10. Other suitable methods of subjecting the green manifold 10 to heat may also be done in accordance with the claims.

In embodiments where an infiltrant is used, the green manifold 10 is subjected to enough heat to cause the infiltrant 86 to melt and move to the voids 84 (see FIG. 9) contained within the manifold 10. The infiltrant will move to the voids 84 by capillary or wicking action as set forth in step S70. Further, sufficient heat will be provided to the manifold 10 so that the grains 80 will start to melt and cause micro-welds to occur at the contact points 82 between the various grains 80 as set forth in step S80. Subjecting green parts to heat to create micro-welds is well known to those of ordinary skill the art and will not be described in additional detail here.

Once the micro-welds have formed at the contact points 82 between the grains 80 and the optional infiltrant 86 has entered the voids 84, the manifold 10 will be allowed to cool as set forth in step S90. In some embodiments the cooling step S90 may include quenching. At this point, the manifold 10 is now unified as the various inner 90 and outer bodies 88 are now welded together. The various grooves 18, 20, 22, 24, 28, 48, and other features of the inner 12, intermediate 42 and outer 30 bodies may be molded and impressed within the green parts by the dies or, in some embodiments various features may be machined into the manifold 10 after it has become unitized through the micro-welding process.

While the embodiments shown in the FIGS. show the manifold made of two or three bodies, one of ordinary skill in the art, after reviewing this disclosure, will understand that manifolds 10 of greater than three bodies may be manufactured in accordance with the claims.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A manifold comprising:
a first body having an outer surface;
a second body having an inner surface corresponding to the outer surface of the first body and the first body is micro-welded to the second body; and
a groove formed in one or both of the outer and inner surfaces, wherein the first body is dimensioned to fit within the second body so that the outer surface contacts the inner surface and the groove forms a fluid passage located between the first and second bodies, the fluid passage having an inlet and an outlet.

2. The manifold of claim 1, wherein the outer surface and the inner surfaces define conic sections.

3. The manifold of claim 1, wherein the outer and inner surfaces are tapered.

4. The manifold of claim 1, wherein the first and second bodies are made of grains of metal.

5. The manifold of claim 4, further compring an infiltrant located between the grains.

6. The manifold of claim 5, wherein the infiltrant is copper.

7. The manifold of claim 4, wherein the grains are micro-welded to each other.

8. The manifold of claim 1, wherein an inlet/outlet for the groove is located in the first body.

9. The manifold of claim 1, further comprising:
a third body having an inner surface and the second body has an outer surface corresponding to the inner surface on the second body; and
a second groove formed in one or both of the outer surface of the second body and the inner surface of the third body, wherein the second body is dimensioned to fit within the third body so that the outer surface on the second body contacts the inner surface on the third body and the second groove forms a fluid passage located in between the second and third bodies, and
wherein the third body is comprised of grains of metal micro-welded to the second body.

10. The manifold of claim 9, wherein the outer surface and the inner surfaces define conic sections.

11. A method of forming a manifold comprising:
filling a die with powdered metal having grains;
compressing the powdered metal in the die thereby forming a first body;
removing the compressed part from the die;
contacting the first body to a second body
subjecting the bodies to heat; and
forming micro-weld between grains of metal between the two bodies.

12. The method of claim 11, further compring adding an infiltrant to at least one of the bodies.

13. The method of claim 12, further comprising filling voids between the grains of powdered metal with the infiltrant.

14. The method of claim 12, wherein the infiltrant includes a metal.

15. The method of claim 14 wherein the infiltrant includes copper.

16. The method of claim 11, further comprising connecting a third body to the first and second bodies and forming micro-welds between grains of metal in the first and second bodies and the second and third bodies.

17. The method of claim 11, further comprising placing the second body in a void in the first body.

18. The method of claim 17, further comprising placing a third body in a void in the second body.

19. The method of claim 17, further comprising forming a tapered surface on an inner diameter of the void in the first body and a tapered surface on an outer diameter of the second body.

20. A manifold comprising:
a first body having an outer surface;
a second body having an inner surface corresponding to the outer surface of the first body, the first body is micro-welded to the second body; and
a means for allowing fluid to move through a body formed in one or both of the outer and inner surfaces, wherein the first body is dimensioned to fit within the second body so that the outer surface contacts the inner surface and the means for allowing fluid to move through a body forms a fluid passage located between the first and second bodies, the fluid passage having an inlet and an outlet.
